(19) United States
(12) Patent Application Publication
(10) Pub. No.: US 2011/0004770 A1
(43) Pub. Date: Jan. 6, 2011

(54) ENCRYPTION SYSTEM THAT PREVENTS ACTIVATION OF COMPUTER VIRUSES

(76) Inventor: Dejan Petkov, Belgrade (RS)

Correspondence Address: Dejan Petkov, Bulevar Arsenija Carnojevica 217/15, Belgrade, 11000, omitted

(21) Appl. No.: 12/497,669

(22) Filed: Jul. 5, 2009

(51) Int. Cl. G06F 12/14

(52) U.S. Cl. 713/188; 713/193

(57) ABSTRACT

System for preventing activation of computer viruses operates in such a way that all executable files must be kept separated from other files and encrypted when written to Hard Disk Drive or Solid State Drive, with a key that is uniquely assigned to this hardware and entered by user. During the reading procedure all data is decrypted automatically by the hardware with the same key written in this hardware and used only for decryption. Since only regular programs can be installed and encrypted with the key known to the user, viruses and the other malicious software can be kept on Hard Disk Drive or Solid State Drive just in plaintext. This causes only regular programs can be sent into the main memory in plaintext, but viruses cannot, because they are destroyed in decryption procedure.

### BACKGROUND OF THE INVENTION

This invention concerns Information Technologies, especially security area, computer virus and other kinds of malicious software protection and prevention.

Present computer viruses and other kinds of malicious software have ability to write their own copies to Hard Disk Drive or Solid State Drive and to activate themselves when the time comes.

Existing techniques for anti-virus protection mostly depend on software which recognizes virus or malicious software code either by comparing its signature to a content in a special database or using some advanced techniques, such as heuristics for detection of viruses which signatures still are not in database.

### BRIEF SUMMARY OF THE INVENTION

This antivirus protection system uses encryption and decryption of executive files during their writing or reading from special, protected part of Hard Disk Drive or Solid State Drive, where only executive files are kept. The system essence is the following: during program writing or installing on computer it is necessary to encrypt the files and keep them encrypted on Hard Disk Drive or Solid State Drive. In this situation the system does not know the encryption key and user must type it. Encryption key is unique for this hardware and every user gets it with the hardware. It is not necessary to protect entire Hard Disk Drive or Solid State Drive by this system. It is sufficient to use this system only on the partitions or parts of Hard Disk Drive or Solid State Drive where executive programs are installed. During the reading procedure, the data is decrypted automatically by the hardware, so plaintext goes to the computer memory and can be executed in processor normally. If working with regular software this procedure makes it possible to be installed and used without any problem. On the other side, if computer virus (or any kind of malicious software) tries to write itself to the Hard Disk Drive or Solid State Drive, it would be written in plaintext format, which means that during reading such file will be put in automatic decrypting procedure, which will destroy it before sending to the memory.

### BRIEF DESCRIPTION OF DRAWINGS

FIG. 1—presents flowchart of data writing procedure to hard disk

FIG. 2—presents data reading procedure from hard disk and sending it to RAM through decrypting module

FIG. 3—presents flowchart of reading regularly encrypted data

FIG. 4—flowchart of reading non-encrypted data from hard disk

FIG. 5—flowchart of virus or malicious software writing on hard disk

FIG. 6—flowchart of virus or malicious software reading, when its code is destroyed during decrypting procedure

### DETAILED DESCRIPTION OF THE INVENTION

The system can be implemented both on hard disk drives (HDD) and Solid State Drives (SSD). In both cases a special protected part of the drive is dedicated to keep only executive files and only those files can be called and executed by the operating system. All other parts of the drive can keep non-executive files, and they can be encrypted or not or protected in some other way. Separating executive and non-executive files makes it possible to prevent virus or other types of malicious software activation.

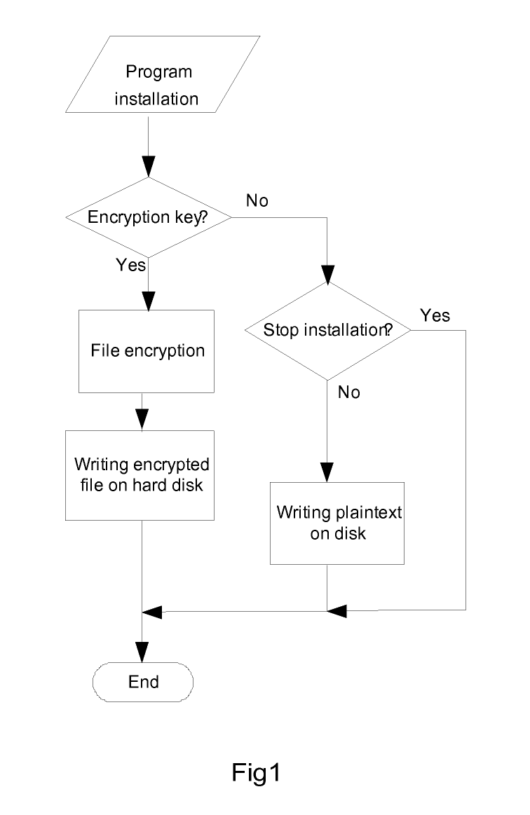

FIG. 1 presents flowchart of file writing procedure to HDD/SSD drive, which include a special step—encryption. This procedure is done by software or by hardware, but not without human intervention. Since the encryption module does not have information about the encryption key it must ask user (human) to enter the key. After user enters the key, the file is written to hard disk in encrypted format. The key is unique for every HDD/SSD drive and it is written in hardware, but kept only for decryption. During the encryption procedure it is not possible using the key written in hardware. The user gets the key written in textual form together with hardware. If user types the key, the file will be encrypted before writing to hard disk and kept there in encrypted format. If user does not enter the key, there are two possibilities: to detect an error or to allow data writing, but in plaintext format. Since this system is dedicated to be used for program installation, this means that only regular executive files will be kept on hard disk properly encrypted.

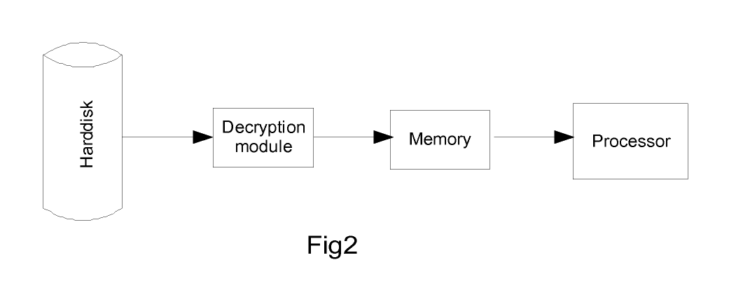

During the reading procedure, as shown on FIG. 2, there is an additional and obligatory step—decrypting. This is hardware module, placed between HDD/SSD drive and memory, probably implemented in drive controller, but it can be made separately. This decrypting is done with a key that is exclusively assigned to this hardware and written in it. In the other words, every single computer hardware has its one unique key (or unique group of keys) used for encryption and decryption of files written to this HDD/SSD drive. The main difference between writing and reading procedure is that during the writing procedure user must enter the key in order to properly encrypt executive files, while during the reading procedure decryption is done automatically by the system, since the key is written in the hardware.

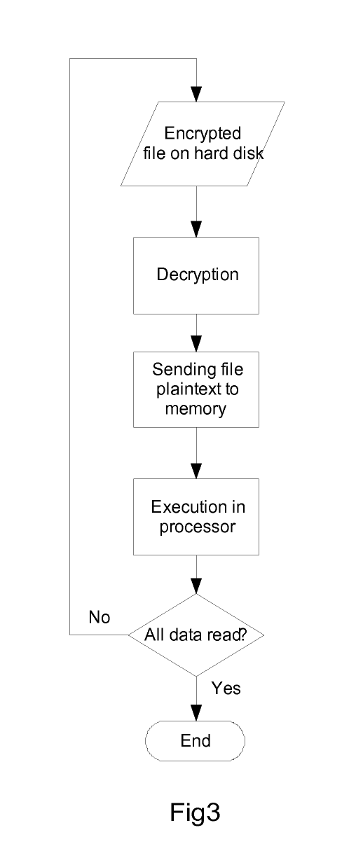

FIG. 3 shows file reading procedure flowchart, mostly used for executive program files. After decrypting chunks of data, they are send to RAM and entire flowchart has cyclic shape. This means that reading will be executed as long as there is data to be sent to memory. Regular executive files are decrypted and sent in plaintext format to memory, and from memory to processor for execution.

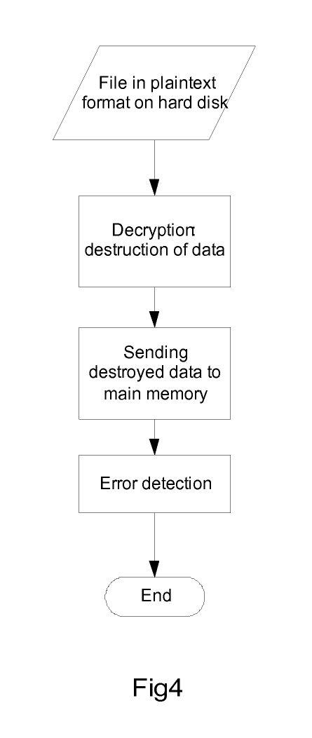

FIG. 4 presents flowchart of reading files that are not regularly written to HDD/SSD drive, which means that they are not placed there in encrypted format. Since decrypting procedure cannot be avoided, such files that are kept on HDD/SSD drive in plaintext are destroyed in hardware decryption module before they are sent to main memory. Such destroyed files cannot be executed, so every attempt to execute them ends by some interrupt and error detection procedure.

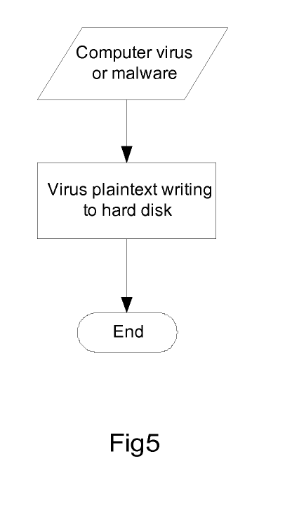

FIG. 5 presents flowchart of virus or other kind of malicious software writing to a HDD/SSD drive. Since such programs usually don't ask user to type the encryption key, because they don't want their installation to be noticed, their files are written to HDD/SSD drive in plaintext.

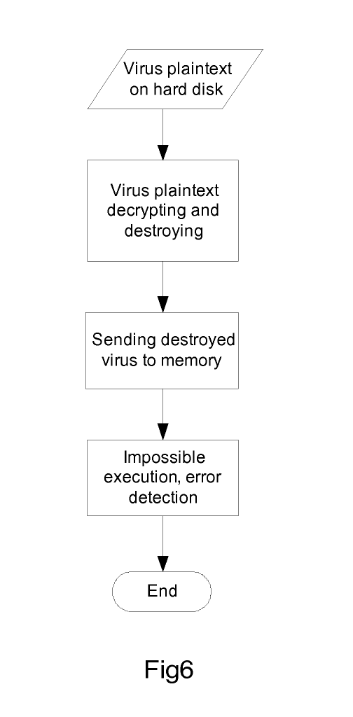

FIG. 6 presents flowchart of attempt of virus activation. Since its code is written to protected part of HDD/SSD drive in plaintext, and must go through decryption module, such malicious programs are destroyed during their transfer to main memory. In the other words, although virus or malicious software copies can be located on HDD/SSD drive, during every single reading such files are decrypted and destroyed, which means that they cannot be activated and executed.

What I claim as my invention is:

1. The encryption system that prevents activation of computer viruses in such a way that during the writing procedure to Hard Disk Drive or Solid State Drive every executable file must be encrypted with the special key that is exclusively assigned to this hardware, but during the software installation must be entered by the user, otherwise installation is stopped or the file is written in plaintext format.

2. The encryption system that prevents activation of computer viruses in such a way that during each file reading from Hard Disk Drive or Solid State Drive, data must be decrypted by hardware module placed between Hard Disk Drive or Solid State Drive and main memory, with the same key that is used in encryption during installation procedure, and which is kept written in hardware for decryption and exclusively assigned to this hardware.

3. The encryption system that prevents activation of computer viruses in such a way that every regular executable file is encrypted during writing to Hard Disk Drive or Solid State Drive and decrypted into plaintext during reading from Hard Disk Drive or Solid State Drive and sending to main memory and processor for execution, while viruses and other types of malicious code are not encrypted because they don't have information about the exclusive encryption key, but placed on Hard Disk Drive or Solid State Drive in plaintext format and destroyed in decryption procedure during data reading from Hard Disk Drive or Solid State Drive, which causes sending irregular executable to main memory which is impossible to execute.
